(19) United States
(12) Patent Application Publication
(10) Pub. No.: US 2008/0286654 A1
(43) Pub. Date: Nov. 20, 2008

(54) NON-AQUEOUS ELECTROLYTE SECONDARY BATTERY

(75) Inventors: Shouichiro Sawa, Moriguchi City (JP); Mariko Torimae, Moriguchi City (JP); Yasuyuki Kusumoto, Moriguchi City (JP); Hiroyuki Fujimoto, Moriguchi City (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: SANYO ELECTRIC CO., LTD., Moriguchi City (JP)

(21) Appl. No.: 12/119,928

(22) Filed: May 13, 2008

(30) Foreign Application Priority Data
May 17, 2007 (JP) 2007-131157
Feb. 8, 2008 (JP) 2008-28287

(51) Int. Cl. H01M 4/58; H01M 10/02

(52) U.S. Cl. 429/231.8; 429/232

(57) ABSTRACT

A non-aqueous electrolyte secondary battery is composed of a positive electrode, a negative electrode, and a non-aqueous electrolyte, and the negative electrode has a negative electrode composite layer containing a negative electrode active material and a binder formed on a negative electrode current collector. The negative electrode active material contains a complex alloy powder containing tin, cobalt and carbon and graphite powder, and the negative electrode composite layer formed on the negative electrode current collector has percentage of porosity within the range of 5 to 20 volume %.

### RELATED APPLICATIONS

This application claims priority from Japanese Patent Application Nos. 2007-131157 and 2008-28287, which are hereby incorporated by reference.

### BACKGROUND OF THE INVENTION

1. Field of the Invention

The present invention relates to non-aqueous electrolyte secondary batteries employing positive electrodes, negative electrodes and non-aqueous electrolytes. More particularly, the invention relates to a non-aqueous electrolyte secondary battery employing a negative electrode forming a negative electrode composite layer containing a negative electrode active material and a binder on a negative electrode current collector, that is configured to attain a non-aqueous electrolyte secondary battery with high capacity and excellent charge-discharge cycle characteristics.

2. Description of Related Art

In recent years, a non-aqueous electrolyte secondary battery employing a non-aqueous electrolyte wherein lithium ion is moved between a positive electrode and a negative electrode to perform charging/discharging has been widely used as a power source of mobile electronic devices and a power supply for electric power storage.

This type of non-aqueous electrolyte secondary battery has been usually utilized a graphite material as a negative electrode active material in its negative electrode.

When the graphite material is used, the non-aqueous electrolyte secondary battery has a flat discharge potential, and charging/discharging is performed by insertion or de-insertion of lithium ion among crystal layers of the graphite material, which prevents precipitation of acicular metal lithium. As a result, the graphite material is advantageous to obtain the non-aqueous electrolyte secondary battery with small variation of volume.

A problem with such a non-aqueous electrolyte secondary battery has been that the graphite material generally does not necessarily have sufficient capacity, and has been difficult to meet demands in recent years for a non-aqueous electrolyte secondary battery with higher capacity to be used for multi-functioned higher performance mobile electronic devices.

Therefore, in recent years, as a negative electrode active material with high capacity, using materials, such as, Si, Zn, Pb, Sn, Ge and Al, for forming an alloy with lithium has been considered.

However, these materials forming an alloy with lithium, have great variation of volume with storage and release of lithium, and repeated charge-discharge cycling causes a particle structure to break and miniaturize, which deteriorates current collectivity of inside of the negative electrode resulting in a remarkable decrease of the capacity.

Therefore, as shown in JP-B2 3624417, there has been disclosed a negative electrode active material obtained by a mechanical alloying materials such as Si, Pb, Sn, Ge, and Al which form an alloy with lithium and have great variations of volume in storing and releasing lithium, and an alloy powder containing Sc, Ti and V.

Further, as shown in JP-A 2006-100244, there has been disclosed a negative electrode active material wherein the main constituent, such as Si, Pb and Al for storing and releasing lithium are alloyed with other metals for stabilizing shape variation of the main constituent associated with storage and release of lithium.

Nevertheless, a problem in using such a negative electrode active material has been that the alloy has great variation of volume and repeated charge-discharge cycling still causes a remarkable decrease of the capacity.

Also, for the purpose of securing sufficient space to meet variations of volume, there has been disclosed in JP-A 2002-367602 a negative electrode with percentage of porosity of 50 to 90 volume % containing a metal or an alloy capable of storing and releasing lithium as a negative electrode active material.

Furthermore, there has been disclosed in JP-B2 3726958 a negative electrode with percentage of porosity of 25 to 65 volume % comprising a negative electrode composite layer of a tin-containing alloy powder.

On the other hand, in order to obtain an electrode with high capacity, not only use of the negative electrode active material alloying with lithium of high capacity material, enhancement of reversible capacity of a battery by improving utilizing rate of the material to be used for the negative electrode active material is required.

Therefore, in addition to tin alloying with lithium, using cobalt and carbon for formation of a complex alloy makes it possible to improve utilizing rate of tin. Further, in this case, because of carbon capable of storing and releasing lithium for charging/discharging contained in the complex alloy, enhancement of reversible capacity of a battery is attained. Particularly, when graphite with high conductivity is used as the carbon, internal resistance of a negative electrode composite layer is decreased and the utilizing rate of complex alloy is improved. Further, when graphite having reversible capacity of 330 mAh/g or more per unit weight is used, capacity and initial charge-discharge efficiency of the negative electrode is improved, and a battery with higher capacity can be obtained.

However, in the case of using the complex alloy containing such graphite as the negative electrode active material, when percentage of porosity in the negative electrode is large as shown in JP-A 2002-367602 and JP-B2 3726958, the negative electrode capacity per unit volume is decreased and a non-aqueous electrolyte secondary battery with high capacity can not be obtained, furthermore, a contact point among the negative electrode active material is decreased by contraction and expansion of the negative electrode active material, and a conductive network of the negative electrode is cut causing an increase of internal resistance of the negative electrode, and as a result, charge-discharge cycle characteristics of the non-aqueous electrolyte secondary battery are deteriorated.

### SUMMARY OF THE INVENTION

It is an object of the present invention to improve a negative electrode wherein a negative electrode composite layer containing a negative electrode active material and a binder is formed on a negative electrode current collector so that a non-aqueous electrolyte secondary battery having excellent charge-discharge cycle characteristics with high capacity can be obtained.

The present invention provides a non-aqueous electrolyte secondary battery comprising a positive electrode, a negative electrode wherein a negative electrode composite layer containing a negative electrode active material and a binder is formed on a negative electrode current collector, and a non-aqueous electrolyte, the negative electrode active material comprises a complex alloy powder containing tin, cobalt and carbon and graphite powder, and percentage of porosity in the negative electrode composite layer formed on the negative electrode current collector is within the range of 5 to 20 volume %.

The above mentioned percentage of porosity is a ratio of volume of porosity to an apparent volume of the negative electrode composite layer. The percentage of porosity is directly measured by a mercury pressurizing method. Also, it may be possible to determine the percentage of porosity as follows. The volume of the negative electrode composite layer is calculated by measuring intrinsic density and weight of the negative electrode composite, then, the volume of the negative electrode composite layer is subtracted from its apparent volume to determine the volume of porosity, and the ratio of the volume of the porosity to the apparent volume of the negative electrode composite layer is determined as the percentage of porosity. The percentage of porosity does not include volume of the negative electrode current collector.

The non-aqueous electrolyte secondary battery of the present invention uses the negative electrode active material containing the complex alloy powder of tin, cobalt and carbon, and the graphite powder. As a consequence, because of tin in the complex alloy alloying with lithium, high capacity is attained, and because of cobalt and carbon in the complex alloy, a utilizing rate of tin is improved.

Also, with the non-aqueous electrolyte secondary battery of the present invention, because of the negative electrode active material containing the graphite powder, conductivity of the negative electrode is improved.

In the invention, the non-aqueous electrolyte secondary battery comprising the negative electrode wherein the negative electrode composite layer containing the negative electrode active material and the binder is formed on the negative electrode current collector, and the negative electrode composite layer has the percentage of porosity of within the range of 5 to 20 volume %. As a consequence, with the non-aqueous electrolyte secondary battery of the present invention, a decrease of contact point among the negative electrode active material is restricted even when the negative electrode active material is expanded or contracted by charging/discharging, a conductive network of the negative electrode is properly maintained, and an increase of internal resistance of the negative electrode by charging/discharging is prevented.

The graphite powder used for the negative electrode active material is anisotropically expanded during charging/discharging. Further, because the graphite powder is oriented into the negative electrode in the case of compression after application, an expansion is easily occurred in a vertical direction particularly during charging/discharging. This is one of the causes of the following drawback. Each of negative electrode active material particle is not expanded to fill the porosity, but the whole negative electrode composite layer forming the conductive network is expanded in the vertical direction to the negative electrode current collector during charging/discharging. Therefore, when the percentage of porosity in the negative electrode composite layer is enlarged as shown in the above-referenced patent documents, the conductive network is broken by volume contraction of the negative electrode active material particle during discharging, and charge-discharge efficiency is degraded. However, as in the present invention, if the percentage of porosity in the negative electrode composite layer is 20 volume % or less, favorable charge-discharge cycle characteristics can be attained.

Further, it may be possible to make thickness of the negative electrode thin by setting the percentage of porosity in the negative electrode composite layer to 20 volume % or less. As a result, even in the case of providing a space in a battery container for relaxing a stress associated with volume variation of the electrode because of expansion of the negative electrode active material, a non-aqueous electrolyte secondary battery with high capacity can be obtained. In the conventional non-aqueous electrolyte secondary battery, in the case that capacity is the same as the present invention, it is impossible to enlarge the space in the battery container, and therefore, stress associated with volume variation of the electrode is large. As a result, there is a fear that charge-discharge cycle characteristics are deteriorated.

As a result, in the non-aqueous electrolyte secondary battery of the present invention, high capacity can be attained restricting deterioration of the negative electrode by charging/discharging, and excellent charge-discharge cycle characteristics can be attained.

These and other objects, advantages and features of the invention will become apparent from the following description thereof taken in conjunction with the accompanying drawings which illustrate specific embodiments of the invention.

### BRIEF DESCRIPTION OF THE DRAWINGS

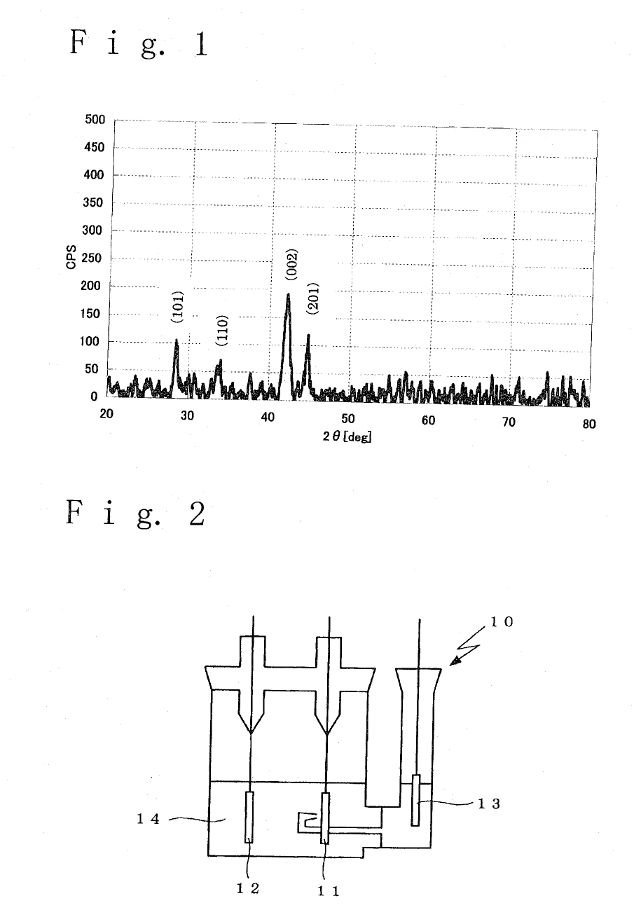

The FIG. 1 is a graph showing the results of X-ray diffraction analysis of a complex alloy powder fabricated for Example 1 of the present invention.

The FIG. 2 is a schematic view illustrating a three-electrode type test cell employing each negative electrode of Examples 1 to 13 and Comparative Examples 1 and 2 as a working electrode.

### DETAILED DESCRIPTION OF THE PREFERRED EMBODIMENTS

Hereinbelow, preferred embodiments of a non-aqueous electrolyte secondary battery are described in further detail. It should be construed, however, that the non-aqueous electrolyte secondary battery according to the present invention is not limited to the following preferred embodiments thereof, but various changes and modifications are possible unless such changes and variations depart from the scope of the invention as defined by the appended claims.

According to the non-aqueous electrolyte secondary battery of the present invention, in a negative electrode comprising a negative electrode composite layer containing a negative electrode active material and a binder formed on a negative electrode current collector, the negative electrode active material contains a complex alloy powder of tin, cobalt and carbon, and graphite powder, and the negative electrode composite layer has percentage of porosity of within the range of 5 to 20 volume %.

A graphite powder preferably used for the negative electrode active material has a lattice plane spacing d 002 of 0.337 nm or less determined by X-ray diffraction analysis, a size Lc of crystal particle in the c-axis direction of not less than 30 nm, and a 50% particle size (median size) D50 of the range of 5 to 35 μm. The use of such a graphite powder makes it possible to decrease the internal resistance of the negative electrode by enhancing the conductivity thereof, so that utilizing rate of the complex alloy, an initial charge-discharge efficiency, and the negative electrode capacity are improved.

In the complex alloy powder of tin, cobalt and carbon used for the negative electrode active material, if a particle size thereof is too small, it becomes impossible to enlarge a contact area among the particles, and a contact point among the particles is decreased. As a result, the conductivity of the negative electrode is lowered. On the other hand, if the particle size thereof is too large, a proportion of the particle size to thickness of the negative electrode composite layer is large and the complex alloy powder is not arranged uniformly in the negative electrode composite layer, so that reaction does not occur uniformly. Therefore, it is preferable to use the complex alloy powder having 50% particle size (median size) D50 of within the range of 5 to 35 μm. More preferably, the complex alloy powder having the above-mentioned D50 of within the range of 10 to 30 μm may be used.

Further, it is preferable to use the complex alloy powder of which carbon atom concentration is within 40 to 80 atomic %. This is because, if concentration of carbon atom contained there is not less than 40 atomic %, tin, cobalt and carbon are easily combined, and structure change of the complex alloy particle is restricted, so that the conductivity of the complex alloy is enhanced and the utilizing rate of tin is improved. On the other hand, if the concentration of the carbon atom is more than 80 atomic %, the concentration of tin contained in the complex alloy is decreased, so that a battery having high capacity can not be obtained.

Also, in order to improve charge-discharge cycle characteristics in the complex alloy powder, the complex alloy powder wherein the concentration of tin is within 45 to 55 atomic % to the total amount of tin and cobalt is preferably used.

Further, as the above-mentioned complex alloy powder, a complex alloy powder of which main peak 2θ appears in the range of 40° to 45° in X-ray diffraction analysis using Cu—Kα radiation, and of which half width is not less than 0.7° , and has a SnCo phase in the complex alloy, may be used. In such a case, charging/discharging reaction occurs uniformly in the complex alloy, and the structure change of the complex alloy particle during repeated charge-discharge cycling is restricted, so that more excellent charge-discharge cycle characteristics can be attained. Further, crystal particle of the complex alloy powder is sufficiently small, and favorable alloy condition is attained.

Also, in addition to tin, cobalt and carbon, another element may be contained in the complex alloy powder. In such a case, in order to enhance combination of the complex alloy without decrease of its capacity, and to improve charge-discharge cycle characteristics with crystal particle smaller, it is preferable that one or more of element selected from titanium, indium, iron, chromium, molybdenum, zirconium, and oxygen may be contained in the concentration of 2 to 20 atomic %.

Further, mechanical milling treatment is preferably applied by using a ball mill or an attritor so that tin, cobalt and carbon are uniformly combined in the complex alloy powder and a complex alloy powder particle having small crystal particle is fabricated.

In preparation of the negative electrode active material containing the complex alloy powder and the graphite powder, if the concentration of the graphite powder in the negative electrode active material is too small, enhancement of conductivity and sufficient restriction of expansion/contraction of the negative electrode active material during charging/discharging are difficult. On the other hand, if the concentration of the graphite powder is too large, the concentration of the complex alloy powder is decreased and a battery having high capacity can not be obtained. Therefore, the negative electrode active material wherein the concentration of the graphite powder to the total amount of the graphite powder and the complex alloy powder is within 20 to 60 mass % is preferably used. More preferably, the negative electrode active material wherein the concentration of the graphite powder is within 30 to 50 mass % is used.

In formation of the negative electrode composite layer containing the negative electrode active material and the binder on the negative electrode current collector, if the amount of the binder in the negative electrode composite layer is too small, adhesive property among the negative electrode active material and that of the negative electrode active material and the negative electrode current collector are reduced and the negative electrode active material is easily separated from the negative electrode current collector. On the other hand, if the amount of the binder in the negative electrode composite layer is too large, the conductivity of the negative electrode is decreased and it is hardly attained that the percentage of porosity in the negative electrode composite layer is 20 volume % or less. Therefore, it is preferable that the amount of binder in the negative electrode composite layer is within 0.4 to 2.0 mass %.

Further, an emulsion-type binder is preferably used as the binder in the negative electrode composite layer. The use of the emulsion-type binder makes it possible to decrease an area of the binder covering the surface of the negative electrode active material without reducing both of the adhesive property among the negative electrode active material, and the adhesive property between the negative electrode active material and the negative electrode current collector. As a result, an area where the negative electrode active material and the non-aqueous electrolyte are contacted with, and a contact area among the negative electrode active material are increased, an efficient charging/discharging is performed, so that initial charge-discharge characteristics and charge-discharge cycle characteristics are improved.

In the case where the emulsion-type binder is used, compared with an aqueous solution-type binder, even if the amount of it is small, the adhesive property among the negative electrode active material and that of the negative electrode active material and the negative electrode current collector are improved. Moreover, the smaller the amount of binder is, the higher the rate of attainment of the effect described above is. Therefore, in the case of using the emulsion-type binder in the negative electrode composite layer, it is preferable that the amount of the binder in the negative electrode composite layer is within the range of 0.4 to 1.0 mass %

Furthermore, in the non-aqueous electrolyte secondary battery according to the present invention, high molecular compounds may be employed as the emulsion-type binder. Examples of the high molecular compounds include fluorine rubber, ethylene-propylene dieneterpolymer (EPDM), styrene-butadiene rubber (SBR), polyethylene, polybutadiene, polytetrafluoroethylene (PTFE), and polyvinyl alcohol (PVA).

Generally, an emulsion-type binder has low viscosity, therefore, in fabrication of negative electrode composite slurry by mixing the emulsion-type binder with the negative electrode active material, a viscosity improver is preferably added for stabilization of the negative electrode composite slurry. As the viscosity improver, carboxymethylcellose sodium salt is preferably employed.

In the non-aqueous electrolyte secondary battery according to the present invention, any known positive electrode active material that has conventionally been used may be used as a positive electrode active material to be used for the positive electrode. Examples of the positive electrode active material include lithium-containing transition metal oxide, metal oxides such as manganese oxide for example MnO₂, and vanadium oxide for example V₂O₅, other oxides, and other sulfides.

Further, examples of usable lithium-containing transition metal oxide include lithium-cobalt multiple oxide for example LiCoO₂, lithium-nickel multiple oxide for example LiNiO₂, lithium-manganese multiple oxide for example LiMn₂O₄ and LiMnO₂, lithium-nickel-cobalt multiple oxide for example LiNi₁₋ₓCoₓO₂ (0<x<1), lithium-manganese-cobalt multiple oxide for example LiMn₁₋ₓCoₓO₂ (0<x<1), lithium-nickel-cobalt-manganese multiple oxide for example LiNiₓCo_{y}Mn_{z}O₂ (x+y+z=1), and lithium-nickel-cobalt-aluminum multiple oxide for example LiNiₓCO_{y}AlO₂ (x+y+z=1)

In the non-aqueous electrolyte secondary battery according to the present invention, a non-aqueous electrolyte wherein a solute is dissolved in known non-aqueous solvent that has been conventionally used may be employed.

Examples of the non-aqueous solvent include a mixed solvent in which a cyclic carbonate such as ethylene carbonate, propylene carbonate and butylene carbonate and a chained carbonate such as dimethyl carbonate, ethyl methyl carbonate and diethyl carbonate are mixed. Alternatively, as the non-aqueous solvent, a mixed solvent in which cyclic carbonate and ether solvent such as 1-2-dimethoxyethane and 1-2-diethoxyethane are mixed may be employed.

Examples of the usable solute include LiPF₆, LiBF₄, LiCF₃SO₃, LiN(CF₃SO₂)₂, LiN(C₂F₅SO₂)₂, LiN(CF₃SO₂)(C₄F₉SO₂), LiC(CF₃SO₂)₃, LiC(C₂F₅SO₂)₃, LiAsF₆, LiClO₄, Li₂B₁₀Cl₁₀, Li₂B₁₂Cl₁₂, which may be used either alone or in combination.

Hereinbelow, examples will be specifically described of the non-aqueous electrolyte secondary battery according to the present invention, and it will be demonstrated by the comparison with comparative examples that the non-aqueous electrolyte secondary batteries in the examples are capable of improving charge-discharge cycle characteristics and initial charge-discharge efficiency.

### EXAMPLE 1

In Example 1, a negative electrode was prepared as follows. A mixture in which tin, cobalt, titanium and indium are mixed at an atomic concentration of 45:45:9:1 was melted and was rapidly cooled at a cooling speed of 10³° C./sec by gas atomizing method to prepare an alloy containing these elements.

Then, 78 parts by weight of the alloy was mixed with 22 parts by weight of acetylene black of carbon material, and a mechanical alloying treatment was applied by using a planetary ball mill in argon atmosphere for 15 hours to prepare a complex alloy powder. After that, the complex alloy powder was taken out into air, and coarse particles were removed therefrom through a sieve having 150 μm mesh aperture. Thus was obtained a complex alloy powder to be used for a negative electrode active material.

Here, the complex alloy powder was measured with an X-ray diffraction analysis by a X-ray diffractometer (a tradename RINT2200 made by Rigaku Corp.) using Cu—Kα tube as a X-ray source. The results were shown in FIG. 1.

As a result, as shown in FIG. 1, main peak corresponding to SnCo (002) plane appeared in a position of 2θ=42.4°, and a half width thereof measured with the X-ray diffractometer application was 0.84° . Further, as shown in FIG. 1, main peak corresponding to SnCo (101) plane appeared in a position of 2θ=28.8°, main peak corresponding to SnCo (110) plane appeared in a position of 2θ=34.0°, and main peak corresponding to SnCo (201) plane appeared in a position of 2θ=44.9°.

Further, according to results of element analysis using a fluorescent X-ray analyzing instrument attached to a scanning electron microscope, 12.5 atomic % of tin, 11.6 atomic % of cobalt, 64.2 atomic % of carbon, 2.2 atomic % of titanium, 0.2 atomic % of indium, 4.6 atomic % of iron, 1.2 atomic % of chromium, and 3.5 atomic % of oxygen were contained in the complex alloy powder.

According to results of measurement using a laser diffraction type particle diameter distribution measurement instrument, 50% diameter size (median size) D50 of the complex alloy powder was 6 μm, 10% diameter size D10 measured from its small diameter side was 1 μm, and 90% diameter size D90 was 16 μm.

According to results of measurement using a dry density measurement instrument, intrinsic density of the complex alloy powder was 4.98 g/cm³.

On the other hand, as graphite powder to be used for the negative electrode active material, scale-shaped artificial graphite powder, having a lattice plane spacing d 002 of 0.336 nm determined by X-ray diffraction analysis, a crystal particle size in the C-axis Lc of 40 nm, and 50% diameter size (median size) D50 of 20 μm, was employed.

According to results of measurement using the dry density measurement instrument, intrinsic density of the scale-shaped artificial graphite powder was 2.26 g/cm³.

Next, 98.4 parts by weight of the negative electrode active material wherein the complex alloy powder and the scale-shaped artificial graphite powder were mixed in the weight ratio of 6:4, 1.6 parts by weight of polyvinylidene fluoride (PVdf) having intrinsic density of 1.78 g/cm³ as the binder, and N-methyl 2-pyrrolidone as the solvent were mixed together to prepare negative electrode composite slurry. The prepared negative electrode composite slurry was applied onto a current collector made of a 10 μm thick copper foil and then heat-dried at 120° C. The resultant material was pressed by roller press to form a negative electrode composite layer on the current collector and thereafter cut into the size of 2 cm×2 cm. Thus, a negative electrode was prepared.

Next, a filling density of the negative electrode composite layer in the negative electrode was determined. Then, intrinsic density of the negative electrode composite was calculated from each of intrinsic density of the complex alloy powder, the scale-shaped artificial graphite powder and the binder. The intrinsic density of the negative electrode composite calculated above was 3.32 g/cm³. Thereafter, percentage of porosity in the negative electrode composite layer was determined according to the following equation using the filling density of the negative electrode composite layer and intrinsic density of the negative electrode composite determined as above. As a result, the percentage of porosity in the negative electrode composite layer was 14 volume %.

Percentage of Porosity(volume %)=(1−filling density÷intrinsic density of negative electrode composite)×100

### EXAMPLE 2

In Example 2, the same procedure as in Example 1 was used to fabricate a non-aqueous electrolyte secondary battery, except that a negative electrode having percentage of porosity in a negative electrode composite layer of 19 volume % was prepared by changing conditions of rolling by rolling press from that of the negative electrode of Example 1.

### COMPARATIVE EXAMPLE 1

In Comparative Example 1, the same procedure as in Example 1 was used to fabricate a non-aqueous electrolyte secondary battery, except that a negative electrode having percentage of porosity in a negative electrode composite layer of 29 volume % was prepared by changing conditions of rolling by rolling press from that of the negative electrode of Example 1.

Here, a three-electrode type cell 10 shown in FIG. 2 was fabricated employing each negative electrode fabricated in Examples 1 and 2 and Comparative Example 1.

In the three-electrode type cell 10, as a working electrode 11, each of the foregoing negative electrodes was employed, and metal lithium was employed as a counter electrode 12 of a positive electrode and as a reference electrode 13. Also, there was employed a non-aqueous electrolyte 14 which was prepared by dissolving lithium hexafluorophosphate LiPF₆ in a concentration of 1.0 mol/l in the mixture solvent containing ethylene carbonate and diethyl carbonate in a volume ratio of 3:7. Next, the working electrode 11, the counter electrode 12 and the reference electrode 13 were soaked in the non-aqueous electrolyte 14 to fabricate each three-electrode type cell 10.

Then, each three-electrode type cell 10 employing each negative electrode of Examples 1, 2 and Comparative Example 1 as the working electrode 11 was charged at a constant current of 0.1 mA/cm² until an electric potential of the working electrode 11 to the reference electrode 13 became 0 V. Thereafter, the forgoing each three-electrode type cell 10 was discharged at the constant current of 0.1 mA/cm² until the electric potential of the working electrode 11 to the reference electrode 13 became 2 V. Thus, a first charge-discharge cycling was conducted.

Next, each three-electrode type cell 10 was charged at a constant current of 0.5 mA/cm² until an electric potential of the working electrode 11 to the reference electrode 13 became 0 V. Thereafter, the three-electrode type cell 10 was discharged at the constant current of 0.5 mA/cm² until the electric potential of the working electrode 11 to the reference electrode 13 became 2 V. Thus, a second charge-discharge cycling was conducted.

Then, in a third charge-discharge cycling or later, each three-electrode type cell 10 was charged at the constant current of 0.5 mA/cm² until the electric potential of the working electrode 11 to the reference electrode 13 became 0 V. Thereafter, the three-electrode type cell 10 was discharged at the constant current of 0.5 mA/cm² until the electric potential of the working electrode 11 to the reference electrode 13 became 1 V. Thus, a discharge capacity Q3 of the third charge-discharge cycling and a discharge capacity Q7 of a seventh charge-discharge cycling were measured and a ratio of the discharge capacity Q7 of the seventh charge-discharge cycling to the discharge capacity Q3 of the third charge-discharge cycling was determined.

In Table 1 below, the above ratio was represented by a charge-discharge cycle characteristic index, wherein the ratio in the case of using the negative electrode of Example 1 was taken as 100. Table 1 shows each of the charge-discharge cycle characteristic indexes in the case of using each negative electrode of Examples 1 and 2 and Comparative Example 1.

TABLE 1

| | | Amount of | Percentage | |
|---|---|---|---|---|
| | | graphite in | of porosity | |
| | | negative | in negative | |
| | Complex | electrode | electrode | Charge- |
| | alloy | active | composite | discharge cycle |
| | powder D50 | material | layer | characteristic |
| | (μm) | (mass %) | (Volume %) | index |
| Example 1 | 6 | 40 | 14 | 100 |
| Example 2 | 6 | 40 | 19 | 87 |
| Comp. | 6 | 40 | 29 | 35 |
| Ex. 1 | | | | |

The results demonstrate that the non-aqueous electrolyte secondary batteries of Examples 1 and 2, which used the negative electrode wherein the percentage of porosity in the negative electrode composite layer was 20 volume % or less, exhibited a remarkable improvement in charge-discharge cycle characteristics compared with the non-aqueous electrolyte secondary battery of Comparative Example 1 which used the negative electrode wherein the percentage of porosity in the negative electrode composite layer was more than 20 volume %.

### EXAMPLE 3

In Example 3, a negative electrode of Example 3 was prepared in the same manner as Example 1 except that a complex alloy powder which remained after being sifted through a sieve having 20 μm mesh aperture was used.

According to results of measurement of the particle diameter of the complex alloy powder in the same manner as Example 1, 50% diameter size (median size) D50 was 16 μm, 10% diameter size D10 measured from its small diameter side was 5 μm, and 90% diameter size D90 was 20 μm.

Further, the percentage of porosity in a negative electrode composite layer of the negative electrode of Example 3 was 15 volume %.

### EXAMPLE 4

In Example 4, a complex alloy powder was dispersed in water and sifted through a sieve having 10 μm mesh aperture. Then, the complex alloy powder remained in the sieve was subjected to vacuum-dry at 100° C. Except for using of the complex alloy powder prepared as above, a negative electrode of Example 4 was prepared in the same manner as Example 1.

According to results of measurement of the particle diameter of the complex alloy powder in the same manner as Example 1, 50% diameter size (median size) D50 was 13 μm, 10% diameter size D10 measured from its small diameter side was 4 μm, and 90% diameter size D90 was 17 μm.

Further, the percentage of porosity in a negative electrode composite layer of the negative electrode of Example 4 was 16 volume %.

### EXAMPLE 5

In Example 5, a negative electrode of Example 5 was prepared in the same manner as Example 1 except that a complex alloy powder which passed through the sieve having 20 μm mesh aperture was used.

According to results of measurement of the particle diameter of the complex alloy powder in the same manner as Example 1, 50% diameter size (median size) D50 was 5 μm, 10% diameter size D10 measured from its small diameter side was 1 μm, and 90% diameter size D90 was 12 μm.

Further, the percentage of porosity in a negative electrode composite layer of the negative electrode of Example 5 was 16 volume %.

Here, in the same manner described as above, a three-electrode type cell 10 shown in FIG. 2 was fabricated employing each negative electrode fabricated in Examples 3 to 5.

Then, each three-electrode type cell 10 was charged and discharged as the same in Example 1 and a ratio of the discharge capacity Q7 of the seventh charge-discharge cycling to the discharge capacity Q3 of the third charge-discharge cycling was determined. Here, the above ratio was represented by a charge-discharge cycle characteristic index, wherein the ratio in the case of using the negative electrode of Example 1 was taken as 100. Table 2 below shows each of the charge-discharge cycle characteristic indexes in the case of using each negative electrode of Examples 3 to 5.

TABLE 2

| | | | Percentage | |
|---|---|---|---|---|
| | | Amount of | of porosity | |
| | | graphite in | in negative | |
| | Complex | negative | electrode | Charge- |
| | alloy | electrode | composite | discharge cycle |
| | powder | active material | layer | characteristic |
| | D50 (μm) | (mass %) | (Volume %) | index |
| Example 1 | 6 | 40 | 14 | 100 |
| Example 3 | 16 | 40 | 15 | 109 |
| Example 4 | 13 | 40 | 16 | 101 |
| Example 5 | 5 | 40 | 16 | 79 |

The results demonstrate that the non-aqueous electrolyte secondary batteries of Examples 3 and 4, which used the complex alloy powder having 50% diameter size (median size) D50 of not less than 10 μm, exhibited a remarkable improvement in charge-discharge cycle characteristics compared with the non-aqueous electrolyte secondary battery of Examples 1 and 5 which used the complex alloy powder having 50% diameter size (median size) D50 of less than 10 μm.

### EXAMPLE 6

In Example 6, a negative electrode active material wherein the complex alloy powder having the same 50% diameter size (median size) D50 of 6 μm as Example 1 was mixed with a scale-shaped artificial graphite powder having a lattice plane spacing determined by X-ray diffraction analysis d 002 of 0.336 nm, a crystal particle size in the C-axis Lc of 40 nm, and 50% diameter size (median size) D50 of 25 μm at a weight ratio of 5:5, was employed. Except for the above, the same procedure as in Example 1 was used to prepare a negative electrode of Example 6.

According to results of measurement, the percentage of porosity in a negative electrode composite layer of the negative electrode of Example 6 was 11 volume %.

### EXAMPLE 7

In Example 7, a negative electrode active material wherein the same scale-shaped artificial graphite powder as Example 6 and the complex alloy powder having the same 50% diameter size (median size) D50 of 6 μm as Example 1 were mixed at a weight ratio of 3:7 was employed. Except for the above, the same procedure as in Example 1 was used to prepare a negative electrode of Example 7.

According to results of measurement, the percentage of porosity in a negative electrode composite layer of the negative electrode of Example 7 was 17 volume %.

### EXAMPLE 8

In Example 8, a negative electrode active material wherein the same scale-shaped artificial graphite powder as Example 6 and the complex alloy powder having the same 50% diameter size (median size) D50 of 6 μm as Example 1 were mixed at a weight ratio of 2:8 was employed. Except for the above, the same procedure as in Example 1 was used to prepare a negative electrode of Example 8.

According to results of measurement, the percentage of porosity in a negative electrode composite layer of the negative electrode of Example 8 was 19 volume %.

### Example 9

In Example 9, a negative electrode active material wherein the same scale-shaped artificial graphite powder as Example 6 and the complex alloy powder having the same 50% diameter size (median size) D50 of 6 μm as Example 1 were mixed at a weight ratio of 1:9 was employed. Except for the above, the same procedure as in Example 1 was used to prepare a negative electrode of Example 9.

According to results of measurement, the percentage of porosity in a negative electrode composite layer of the negative electrode of Example 9 was 19 volume %.

### COMPARATIVE EXAMPLE 2

In Comparative Example 2, a negative electrode of Comparative Example 2 was prepared in the same manner as Example 1 except that the complex alloy powder having the same 50% diameter size (median size) D50 of 6 μm as Example 1 was employed as the complex alloy powder without scale-shaped artificial graphite powder.

According to results of measurement, the percentage of porosity in a negative electrode composite layer of the negative electrode of Comparative Example 2 was 28 volume %.

Here, in the same manner described as above, a three-electrode type cell 10 shown in FIG. 2 was fabricated employing each negative electrode fabricated in Examples 6 to 9 and Comparative Example 2.

Then, each three-electrode type cell 10 was charged and discharged as the same in Example 1 and an initial discharge capacity at the first cycle was determined and a ratio of the discharge capacity Q7 of the seventh charge-discharge cycling to the discharge capacity Q3 of the third charge-discharge cycling was determined. Here, the above ratio was represented by a charge-discharge cycle characteristic index, wherein the ratio in the case of using the negative electrode of Example 8 was taken as 100. Table 3 below shows each of the charge-discharge cycle characteristic indexes in the case of using each negative electrode of Examples 6 to 9 and Comparative Example 2.

TABLE 3

| | | | Percentage | | |
|---|---|---|---|---|---|
| | | Amount of | of | | |
| | | graphite | porosity | | |
| | | in | in | Charge- | |
| | Complex | negative | negative | discharge | |
| | alloy | electrode | electrode | cycle | Initial |
| | powder | active | composite | char- | discharge |
| | D50 | material | layer | acteristic | capacity |
| | (μm) | (mass %) | (volume %) | index | (mAh/g) |
| Example 6 | 6 | 50 | 11 | 117 | 357 |
| Example 7 | 6 | 30 | 17 | 108 | 373 |
| Example 8 | 6 | 20 | 19 | 100 | 372 |
| Example 9 | 6 | 10 | 19 | 87 | 371 |
| Comp. | 6 | — | 28 | 53 | 364 |
| Ex. 2 | | | | | |

The results demonstrate that the non-aqueous electrolyte secondary batteries of Examples 6 to 9, which used the negative electrode active material mixing the graphite powder and the complex alloy powder, exhibited a remarkable improvement in charge-discharge cycle characteristics compared with the non-aqueous electrolyte secondary battery of Comparative Example 2 which used the negative electrode active material containing the complex alloy powder only and not containing the graphite powder.

Further, the results demonstrate that the non-aqueous electrolyte secondary batteries of Examples 6 to 8, which used the negative electrode active material wherein the amount of the graphite powder was not less than 20 mass %, exhibited a remarkable improvement in charge-discharge cycle characteristics compared with the non-aqueous electrolyte secondary battery of Example 9 which used the negative electrode active material wherein the amount of the graphite powder was less than 20 mass %.

With regard to comparison among the initial discharge capacity, the non-aqueous electrolyte secondary battery of Example 6 which used the negative electrode active material wherein the amount of the graphite powder was 50 mass % showed a little lower initial discharge capacity, however, difference between the non-aqueous electrolyte secondary battery of Comparative Example 2 which used the negative electrode active material containing only the composite alloy powder was not great. The non-aqueous electrolyte secondary batteries of Examples 7 to 9 which used the negative electrode active material wherein the amount of the graphite powder was 30 mass % or less showed a higher initial discharge capacity, compared with the non-aqueous electrolyte secondary battery of Comparative Example 2. The reason is thought to be that utilizing rate of the composite alloy powder is improved by addition of the graphite powder.

### EXAMPLE 10

In Example 10, the same negative electrode active material as Example 1 was used to prepare negative electrode composite slurry as follows. 98.4 parts by weight of the forgoing negative electrode active material, 0.8 parts by weight in terms of solid components of styrene-butadiene rubber (SBR) of emulsion-type binder having intrinsic density of 0.91 g/cm³, and 0.8 parts by weight of carboxymethylcellose sodium salt (CMC) of viscosity improver having intrinsic density of 1.35 g/cm³ were kneaded with water of a solvent.

Next, the prepared negative electrode composite slurry was applied onto a current collector made of a 10 μm thick copper foil and then heat-dried at 120° C. The resultant material was pressed by roller press to form a negative electrode composite layer on the current collector and thereafter cut into the size of 2 cm×2 cm. Thus, a negative electrode of Example 10 was prepared.

According to results of measurement, the percentage of porosity in the negative electrode composite layer of the negative electrode of Example 10 was 16 volume %.

### EXAMPLE 11

In Example 11, the same procedure as in Example 10 was used to prepare a negative electrode of Example 11 except that 98.8 parts by weight of the same negative electrode active material as Example 10, 0.8 parts by weight in terms of solid components of styrene-butadiene rubber (SBR) of emulsion-type binder, and 0.4 parts by weight of carboxymethylcellose sodium salt (CMC) of viscosity improver were used.

According to results of measurement, the percentage of porosity in a negative electrode composite layer of the negative electrode of Example 11 was 15 volume %.

### EXAMPLE 12

In Example 12, the same procedure as in Example 10 was used to prepare a negative electrode of Example 12 except that 99.2 parts by weight of the negative electrode active material of Example 10, 0.4 parts by weight in terms of solid components of styrene-butadiene rubber (SBR) of emulsion-type binder, and 0.4 parts by weight of carboxymethylcellose sodium salt (CMC) of viscosity improver were used.

According to results of measurement, the percentage of porosity in a negative electrode composite layer of the negative electrode of Example 12 was 15 volume %.

### EXAMPLE 13

In Example 13, the same procedure as in Example 10 was used to prepare a negative electrode of Example 13 except that 97.5 parts by weight of the negative electrode active material of Example 10, 1.5 parts by weight in terms of solid components of styrene-butadiene rubber (SBR) of emulsion-type binder, and 1.0 parts by weight of carboxymethylcellose sodium salt (CMC) of viscosity improver were used.

According to results of measurement, the percentage of porosity in a negative electrode composite layer of the negative electrode of Example 13 was 20 volume %.

Here, in the same manner described as above, a three-electrode type cell 10 shown in FIG. 2 was fabricated employing each negative electrode fabricated in Examples 10 to 13.

Then, each three-electrode type cell 10 was charged and discharged as the same in Example 1 and a ratio of a discharge capacity at the first charge-discharge cycling to a charge capacity at the first charge-discharge cycling (initial charge-discharge efficiency) was determined. Also, the discharge capacity Q7 of the seventh charge-discharge cycling to the discharge capacity Q3 of the third charge-discharge cycling was determined.

Here, the above ratio was represented by a charge-discharge cycle characteristic index, wherein the ratio in the case of using the negative electrode of Example 1 was taken as 100. Table 4 below shows each of the charge-discharge cycle characteristic indexes in the case of using each negative electrode of Examples 10 to 13.

TABLE 4

| | | | | | Charge- |
|---|---|---|---|---|---|
| | Negative electrode composite layer | | | Initial | discharge |
| | | Viscosity | | charge- | cycle |
| | Binder | improver | Percentage | discharge | char- |
| | (content by | (content by | of | efficiency | acteristic |
| | amount) | amount) | porosity | (%) | index |
| Ex. 10 | SBR | CMC | 16 vol. % | 91 | 102 |
| | (0.8 mass %) | (0.8 mass %) | | | |
| Ex. 11 | SBR | CMC | 15 vol. % | 91 | 105 |
| | (0.4 mass %) | (0.8 mass %) | | | |
| Ex. 12 | SBR | CMC | 15 vol. % | 91 | 103 |
| | (0.4 mass %) | (0.4 mass %) | | | |
| Ex. 13 | SBR | CMC | 20 vol. % | 90 | 100 |
| | (1.5 mass %) | (1.0 mass %) | | | |
| Ex. 1 | PVdF | — | 14 vol. % | 89 | 100 |
| | (1.6 mass %) | | | | |

The results demonstrate that the non-aqueous electrolyte secondary batteries of Examples 10 to 13, which used the negative electrode comprising the negative composite layer containing styrene-butadiene rubber (SBR) of emulsion-type binder and carboxymethylcellose sodium salt of viscosity improver, exhibited an improvement in initial charge-discharge efficiency compared with the non-aqueous electrolyte secondary battery of Example 1 which used the negative electrode employing polyvinylidene fluoride (PVdf) as the binder.

Particularly, the results demonstrate that the non-aqueous electrolyte secondary batteries of Examples 10 to 12, which used the negative electrode comprising the negative electrode composite layer containing 1 mass % or less of styrene-butadiene rubber (SBR) of emulsion-type binder, exhibited a further improvement in initial charge-discharge efficiency as well as an improvement in charge-discharge cycle characteristics.

Although the present invention has been fully described by way of examples, it is to be noted that various changes and modification will be apparent to those skilled in the art.

Therefore, unless otherwise such changes and modifications depart from the scope of the present invention, they should be construed as being included therein.

1. A non-aqueous electrolyte secondary battery comprising a positive electrode, a negative electrode, and a non-aqueous electrolyte, the negative electrode having a negative electrode composite layer containing a negative electrode active material and a binder formed on a negative electrode current collector, wherein
the negative electrode active material comprises a complex alloy powder containing tin, cobalt and carbon and graphite powder, and the negative electrode composite layer formed on the negative electrode current collector has percentage of porosity within the range of 5 to 20 volume %.

2. The non-aqueous electrolyte secondary battery according to claim 1, wherein the graphite powder to be used for the negative electrode active material has a lattice plane spacing d 002 of 0.337 nm or less determined by X-ray diffraction analysis, a size Lc of crystal particle in the c-axis direction of not less than 30 nm, and a 50% particle size, median size D50 of within the range of 5 to 35 μm.

3. The non-aqueous electrolyte secondary battery according to claim 1, wherein the complex alloy powder to be used for the negative electrode active material has 50% particle size, median size D50 of within the range of 5 to 35 μm.

4. The non-aqueous electrolyte secondary battery according to claim 1, wherein concentration of the graphite powder to the total amount of the graphite powder and the complex alloy powder to be used for the negative electrode active material is within 20 to 60 mass %.

5. The non-aqueous electrolyte secondary battery according to claim 1, wherein concentration of the graphite powder to the total amount of the graphite powder and the complex alloy powder to be used for the negative electrode active material is within 30 to 50 mass %.

6. The non-aqueous electrolyte secondary battery according to claim 1, wherein the complex alloy powder to be used for the negative electrode active material has carbon atom concentration of within 40 to 80 atomic %.

7. The non-aqueous electrolyte secondary battery according to claim 1, wherein the complex alloy powder to be used for the negative electrode active material contains tin in a concentration of within 45 to 55 atomic % to the total amount of tin and cobalt.

8. The non-aqueous electrolyte secondary battery according to claim 1, wherein the complex alloy powder to be used for the negative electrode active material has a main peak 2θ which appears in the range of 40° to 45° in X-ray diffraction analysis using Cu—Kα radiation, and has a half width of not less than 0.7°.

9. The non-aqueous electrolyte secondary battery according to claim 1, wherein the complex alloy powder to be used for the negative electrode active material has a SnCo phase.

10. The non-aqueous electrolyte secondary battery according to claim 1, wherein the amount of binder in the negative electrode composite layer is within 0.4 to 2.0 mass %.

11. The non-aqueous electrolyte secondary battery according to claim 1, wherein the binder in the negative electrode composite layer is an emulsion-type binder.

12. The non-aqueous electrolyte secondary battery according to claim 1, wherein the binder in the negative electrode composite layer is styrene-butadiene rubber.

13. The non-aqueous electrolyte secondary battery according to claim 11, wherein the negative electrode composite layer contains carboxymethylcellose of a viscosity improver.
